(19) United States
(12) Patent Application Publication
(10) Pub. No.: US 2016/0118061 A1
(43) Pub. Date: Apr. 28, 2016

(54) ELECTRONIC DEVICE, METHOD, AND COMPUTER PROGRAM PRODUCT

(71) Applicant: Kabushiki Kaisha Toshiba, Tokyo (JP)

(72) Inventor: Takashi SUDO, Fuchu Tokyo (JP)

(21) Appl. No.: 14/681,928

(22) Filed: Apr. 8, 2015

Related U.S. Application Data
(60) Provisional application No. 62/068,358, filed on Oct. 24, 2014.

(51) Int. Cl. G10L 25/63; H04R 29/00

(52) U.S. Cl. CPC G10L 25/63; H04R 29/00

(57) ABSTRACT

In general, according to one embodiment, an electronic device includes circuitry. The circuitry is configured to acquire audio data obtained by collecting sounds around the electronic device, and to identify, based on the acquired audio data, the type of the surrounding environment using a density of people around the electronic device or information as to whether a surrounding natural environment is present.

### CROSS-REFERENCE TO RELATED APPLICATION

This application claims the benefit of U.S. Provisional Patent Application No. 62/068,358, filed Oct. 24, 2014.

### FIELD

Embodiments described herein relate generally to an electronic device, a method, and a computer program product.

### BACKGROUND

In these years, as computer technologies progress, users of electronic devices more and more tend to carry them while leading their daily life.

Such electronic devices as described above often comprise various sensors and can often communicate with other electronic devices, thus more and more tending to store information on the users leading their daily life.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating a configuration example of an information system according to a first embodiment;

FIG. 2 is an exemplary diagram illustrating a hardware configuration example of a wearable computer in the first embodiment;

FIG. 3 is an exemplary diagram illustrating a hardware configuration example of a personal digital assistant in the first embodiment;

FIG. 4 is an exemplary block diagram illustrating configurations in the wearable computer and the personal digital assistant in the first embodiment;

FIG. 5 is an exemplary diagram illustrating a database structure of an ambient environmental sound dictionary in the first embodiment;

FIG. 6 is an exemplary diagram illustrating a transition of stress changing with time displayed on a display unit in the first embodiment;

FIG. 7 is an exemplary flowchart illustrating a processing procedure until an integrated amount of an environmental stress value is recorded in the personal digital assistant in the first embodiment;

FIG. 8 is an exemplary diagram illustrating a configuration example of an information system according to a second embodiment;

FIG. 9 is an exemplary block diagram illustrating configurations in a wearable computer and a personal digital assistant in the second embodiment;

FIG. 10 is an exemplary diagram illustrating pulse wave data in the second embodiment;

FIG. 11 is an exemplary diagram illustrating an example in which pulse intervals are changed to convert data into isochronous data in the second embodiment;

FIG. 12 is an exemplary diagram illustrating a power spectral density calculated from the pulse wave data in the second embodiment;

FIG. 13 is an exemplary diagram illustrating a transition of an instantaneous stress value in the second embodiment;

FIG. 14 is an exemplary flowchart illustrating a processing procedure until an accumulated stress amount is recorded in the personal digital assistant in the second embodiment; and

FIG. 15 is an exemplary block diagram illustrating configurations in a wearable computer and a personal digital assistant in a modification.

### DETAILED DESCRIPTION

In general, according to an embodiment, an electronic device comprises circuitry. The circuitry is configured to: acquire audio data obtained by collecting sounds around the electronic device; and identify, based on the acquired audio data, the type of the surrounding environment using a density of people around the electronic device or information as to whether a surrounding natural environment is present.

The following specifically describes embodiments based on the drawings. While the following describes an example of applying technologies of the embodiments to a personal digital assistant, the technologies of the embodiments are also applicable to electronic devices other than the personal digital assistant.

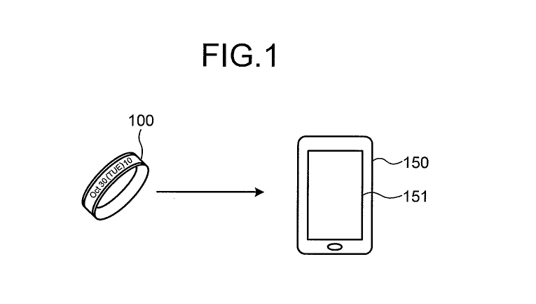

FIG. 1 is a diagram illustrating a configuration example of an information system according to a first embodiment. As illustrated in FIG. 1, the information system comprises a wearable computer 100 and a personal digital assistant 150.

The wearable computer 100 of the present embodiment is an electronic device that has a shape wearable on a part of the body of a user and houses a microphone and various sensors including an acceleration sensor.

The wearable computer 100 also comprises a wireless communication module. As a result, using the wireless communication module, the wearable computer 100 can send data detected by the various sensors to another electronic device (such as the personal digital assistant 150).

In addition, the wearable computer 100 can detect biological data (such as pulse beats, heartbeats, amounts of activity including a step count and consumed calories, a body temperature, a perspiration amount, and a depth of sleep) of the user wearing the wearable computer 100. Such biological data can also be sent to the other electronic device.

The personal digital assistant 150 comprises a wireless communication module and can send and receive data to and from another electronic device (such as the wearable computer 100). The personal digital assistant 150 also comprises a nonvolatile memory, and can thereby store various kinds of data.

As a result, the personal digital assistant 150 of the present embodiment can create a life log of the user wearing the wearable computer 100 by storing the data received from the wearable computer 100 in a manner associated with time.

In addition, the personal digital assistant 150 of the present embodiment comprises a display unit 151, and can thereby display advice based on the information received from the wearable computer.

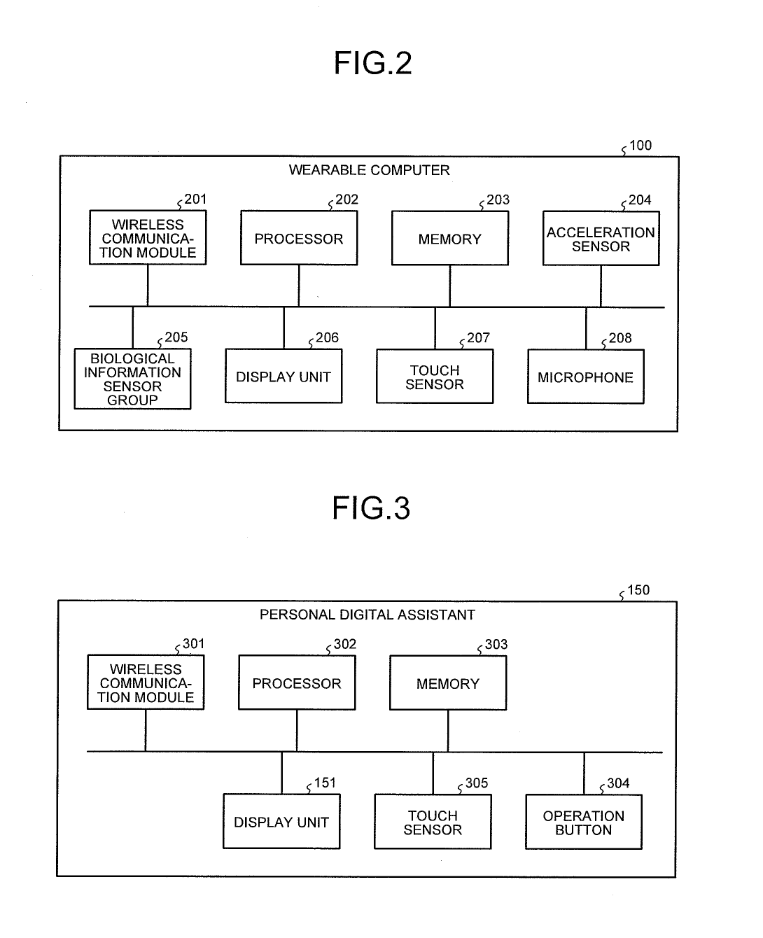

FIG. 2 is a diagram illustrating a hardware configuration example of the wearable computer 100 of the present embodiment. As illustrated in FIG. 2, the wearable computer 100 comprises a wireless communication module 201, a processor 202, a memory 203, an acceleration sensor 204, a biological information sensor group 205, a display unit 206, a touch sensor 207, and a microphone 208.

The wireless communication module 201 enables communication with electronic devices, such as the personal digital assistant 150, using wireless communication.

The memory 203 comprises, for example, a read-only memory (ROM) and a random access memory (RAM), and can store various kinds of information, such as computer programs executed by the processor 202 and data used by the processor 202 when executing the programs.

The processor 202 is, for example, a central processing unit (CPU), and comprises an electronic circuit that can control the entire wearable computer 100. The processor 202 of the present embodiment is configured to execute the programs stored in the memory 203 so as to implement various functions.

The acceleration sensor 204 detects acceleration data.

The biological information sensor group 205 can detect the biological information (such as the pulse beats, the heartbeats, the amounts of activity, the body temperature, the perspiration amount, and the depth of sleep) of the user wearing the wearable computer 100.

The microphone 208 collects sounds around the wearable computer 100 so as to obtain audio data. In the present embodiment, the microphone 208 converts the obtained audio data into a digital signal, and then outputs the digital signal.

The display unit 206 is a liquid crystal display (LCD) or an organic electroluminescent (EL) display for displaying various kinds of information, such as detection results of the biological information of the user wearing the wearable computer 100.

The touch sensor 207 detects the position on the display screen of the display unit 206 where a touch operation is made.

According to needs, the wearable computer 100 sends the detected biological information of the user and the information on the audio data to the personal digital assistant 150 via the wireless communication module 201.

The personal digital assistant 150 will be described below. FIG. 3 is a diagram illustrating a hardware configuration example of the personal digital assistant 150 of the present embodiment. As illustrated in FIG. 3, the personal digital assistant 150 comprises a wireless communication module 301, a processor 302, a memory 303, an operation button 304, and a display unit 151.

The wireless communication module 301 enables communication with electronic devices, such as the wearable computer 100, using wireless communication.

The memory 303 comprises, for example, a read-only memory (ROM) and a random access memory (RAM), and can store various kinds of information, such as computer programs executed by the processor 302 and data used by the processor 302 when executing the programs.

The processor 302 is, for example, a central processing unit (CPU), and comprises an electronic circuit that can control the entire personal digital assistant 150. The processor 302 of the present embodiment is configured to execute the programs stored in the memory 303 so as to implement various functions.

The display unit 151 is a liquid crystal display (LCD) or an organic electroluminescent (EL) display for displaying various kinds of information.

The operation button 304 is provided on the personal digital assistant 150, and receives an operation from the user. The touch sensor 305 detects the position on the display screen of the display unit 151 where a touch operation is made.

The personal digital assistant 150 of the present embodiment records the information received from the wearable computer 100 in the memory 303, and, according to needs, performs display on the display unit 151 based on the received information.

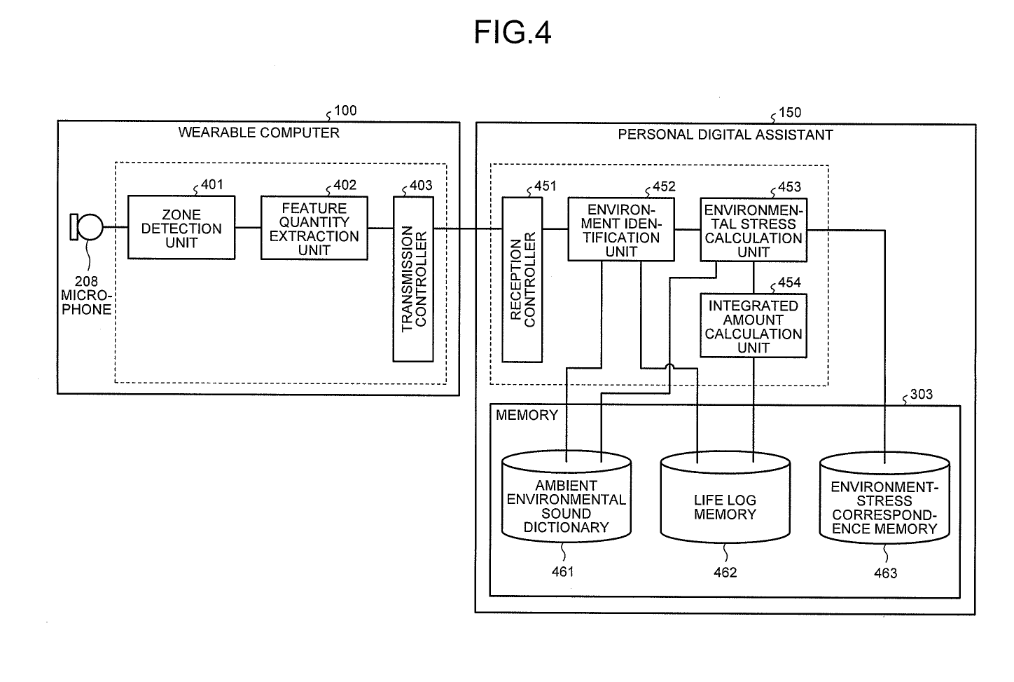

A description will be given of configurations implemented in the wearable computer 100 and the personal digital assistant 150 by executing the programs. FIG. 4 is a block diagram illustrating the configurations in the wearable computer 100 and the personal digital assistant 150 of the present embodiment.

As illustrated in FIG. 4, in the wearable computer 100, the processor 202 implements at least a zone detection unit 401, a feature quantity extraction unit 402, and a transmission controller 403 by executing the programs stored in the memory 203.

The zone detection unit 401 detects a noise zone that does not include human voices or the like from the audio data obtained by collecting sounds around the wearable computer 100 with the microphone 208, and thus extracts audio data in the noise zone. The zone detection unit 401 outputs the audio data composed of the noise of the surrounding environment that does not include human voices or the like to the feature quantity extraction unit 402.

The feature quantity extraction unit 402 calculates the feature quantity of audio data from the audio data composed of the noise of the surrounding environment received from the zone detection unit 401. While the present embodiment employs a sound volume, a power spectrum, and a 1/f fluctuation as the feature quantity of the audio data, any data may be employed that represents the feature of sound.

The transmission controller 403 controls transmission of data to another electronic device (such as the personal digital assistant 150) via the wireless communication module 201. In the present embodiment, the transmission controller 403 controls transmission of the feature quantity of the audio data extracted by the feature quantity extraction unit 402 to the personal digital assistant 150.

As illustrated in FIG. 4, in the personal digital assistant 150, the processor 302 implements at least a reception controller 451, an environment identification unit 452, an environmental stress calculation unit 453, and an integrated amount calculation unit 454 by executing the programs stored in the memory 303.

The personal digital assistant 150 stores at least an ambient environmental sound dictionary 461 and a life log memory 462 in the memory 303.

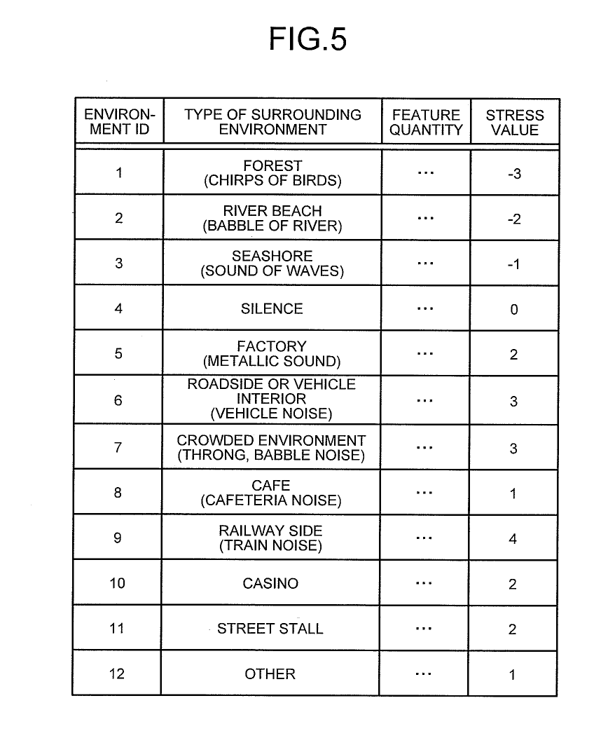

The ambient environmental sound dictionary 461 is a database used for identifying the type of the surrounding environment based on the feature quantity of the audio data. FIG. 5 is a diagram illustrating a database structure of the ambient environmental sound dictionary 461. As illustrated in FIG. 5, the ambient environmental sound dictionary 461 stores an environment identifier (ID), the type of the surrounding environment, the feature quantity, and a stress value in a manner associated with each other. The ambient environmental sound dictionary 461 is provided with an environment ID for “other” that does not apply to any type.

The ambient environmental sound dictionary 461 of the present embodiment associates the feature quantity of the audio data with the type of the surrounding environment, so that the type of the surrounding environment in which the user resides can be identified based on the feature quantity of the audio data received from the wearable computer 100.

The type of the surrounding environment in the present embodiment is classified in connection with the stress of the user, and is determined using at least one of the density of people around the wearable computer 100 and the information as to whether a surrounding natural environment is present. Thus, by identifying the type of the surrounding environment, it is possible to estimate what kind of influence the surrounding environment has on the stress of the user.

In addition, the ambient environmental sound dictionary 461 associates the environment ID and the type of the surrounding environment with the stress value, so that an environmental stress value based on the environment around the user can be identified. In the present embodiment, an example will be described that uses the environmental stress value that numerically represents the stress level based on the environment around the user. The stress level of the user may, however, be represented by something other than a numerical value.

In the database illustrated in FIG. 5, as an example, when nature lies around the user, the environmental stress value is set so that the stress level is lower than that when nature does not lie around the user. Also, in the database, as an example, when people are dense (the density of people is high in a crowd or a train) around the user, the environmental stress value is set so that the stress level is higher than that when people are not dense (the density of people is low) around the user. However, the ambient environmental sound dictionary only needs to be a dictionary that can identify the environmental stress value based on the environment around the user, and may be designed based on other concepts.

The life log memory 462 is a storage area for recording a log about the user wearing the wearable computer 100 on a part of the body thereof.

The reception controller 451 controls reception of data from another electronic device (such as the wearable computer 100) via the wireless communication module 301. In the present embodiment, the reception controller 451 controls reception of the feature quantity of the audio data from the wearable computer 100.

Based on the feature quantity of the audio data received under the control of the reception controller 451 and on the ambient environmental sound dictionary 461, the environment identification unit 452 identifies the type of the surrounding environment in which the user resides.

The environment identification unit 452 of the present embodiment calculates likelihoods between the feature quantity of the audio data obtained by the reception control and the respective feature quantities recorded in the ambient environmental sound dictionary 461, and identifies the environment ID associated with the feature quantity giving the maximum the likelihood as the electronic device, in other words, identification information representing the type of the environment around the user wearing the electronic device. Thus, the present embodiment can identify the environment or the place in which the user resides, based on the sound of the surrounding area collected by the microphone 208.

The environment identification unit 452 continues to register the environment ID indicating the identified type of the surrounding environment and time, in a manner associated with each other, in the life log memory 462.

With reference to the ambient environmental sound dictionary 461, the environmental stress calculation unit 453 calculates, as the environmental stress value, the stress value associated with the environment ID identified by the environment identification unit 452.

The integrated amount calculation unit 454 calculates an integrated value based on the environmental stress value calculated by the environmental stress calculation unit 453. In the present embodiment, an initial value of the integrated value is set at the start of the personal digital assistant 150. The integrated amount calculation unit 454 derives the integrated value by performing addition or subtraction between the initial value and the stress value calculated by the environmental stress calculation unit 453. Thereafter, the integrated amount calculation unit 454 applies a mathematical operation to the integrated value using the environmental stress value calculated by the environmental stress calculation unit 453. Such mathematical operations may be applied at predetermined intervals of time.

In the present embodiment, a range in which the environmental stress value varies may be set for each type of the surrounding environment. For example, the range may be set so that the environmental stress value increases up to 10 at the most even while the type of the surrounding environment continues to be “factory”.

The integrated amount calculation unit 454 continues to register the calculated integrated value and time, in a manner associated with each other, in the life log memory 462. Thus, a change in the environmental stress value of the user is stored.

The processor 302 of the personal digital assistant 150 can display the transition of the integrated value stored in the life log memory 462 on the display unit 151.

In the present embodiment, an example will be described in which the processor 302 outputs the transition of the integrated value representing the stress level of the user to the display unit 151. The output destination is, however, not limited. The output destination may be, for example, a communication device, via a communication network.

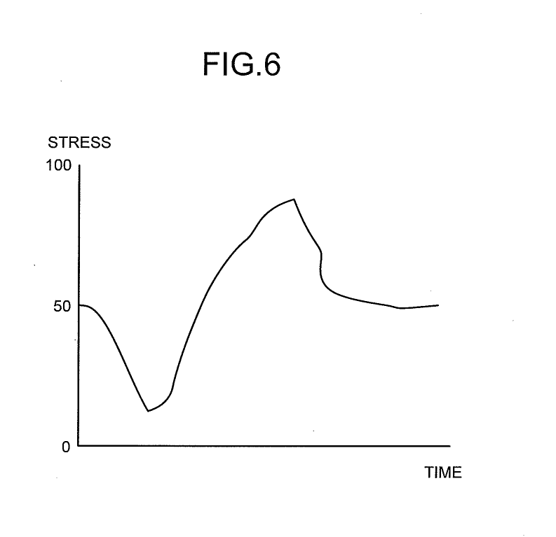

FIG. 6 is a diagram illustrating the transition of the stress changing with time displayed on the display unit 151. In the example illustrated in FIG. 6, the initial value is 50, and the integrated value changes based on the environmental stress value calculated by the environmental stress calculation unit 453. The example illustrated in FIG. 6 is an example in which the user is more relaxed as the stress is closer to 0, and more stressed as the stress is closer to 100.

Based on the correspondence relations stored in the life log memory 462, the processor 302 displays, on the display unit 151, information on the time period during which the user has resided in an environment corresponding to the environment ID. The display may be performed using a method in which, for example, the time period during which the user has resided in each environment is displayed in a corresponding manner to the environment.

Thus, by implementing the configuration described above, the processor 302 acquires the feature quantity of the audio data, and, based on the acquired feature quantity of the audio data, identifies the type of the surrounding environment based on at least one of the density of surrounding people and the information as to whether a surrounding natural environment is present.

In addition, as described above, based on the identified type of the surrounding environment, when the people are dense around the user, the processor 302 determines that the stress level of the user is higher than that when the people are not dense around the user. Moreover, when nature lies around the user, the processor 302 determines that the stress level of the user is lower than that when nature does not lie around the user. In the present embodiment, the example has been described that calculates the environmental stress value of the user by combining the density of the people with presence of nature. The environmental stress value of the user may, however, be calculated based on either one of the density of the people and the presence of nature.

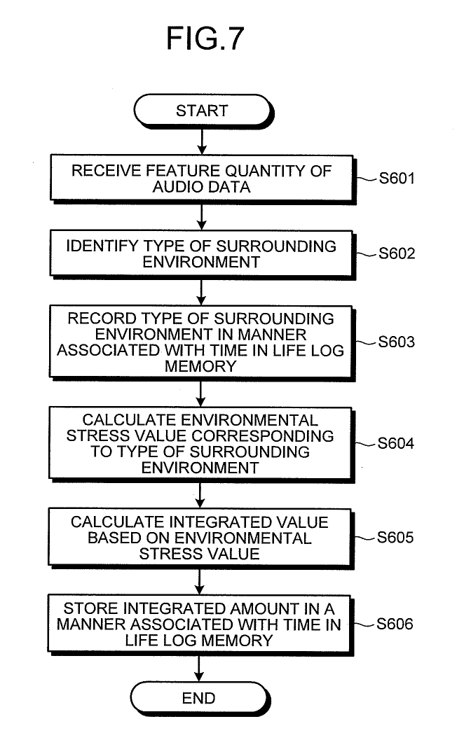

A description will be given of a processing procedure until the integrated amount of the environmental stress value is recorded in the personal digital assistant 150. FIG. 7 is a flowchart illustrating the above-described processing procedure in the personal digital assistant 150 of the present embodiment.

First, the reception controller 451 receives the feature quantity of the audio data from the wearable computer 100 (S601). Then, the environment identification unit 452 identifies the type of the surrounding environment based on the ambient environmental sound dictionary 461 and the feature quantity of the audio data (S602).

The environment identification unit 452 then records the type of the surrounding environment, in a manner associated with time, in the life log memory 462 (S603).

Thereafter, with reference to the ambient environmental sound dictionary 461, the environmental stress calculation unit 453 calculates the environmental stress value corresponding to the type of the surrounding environment (S604).

Then, the integrated amount calculation unit 454 calculates the integrated value based on the calculated environmental stress value (S605). The integrated amount calculation unit 454 stores the calculated integrated value, in a manner associated with time, in the life log memory 462 (S606).

The above-described processing procedure records the type of the surrounding environment and the integrated value of the environmental stress value that change with time, in the life log memory 462. As a result, the user can display the information on the type of the surrounding environment and the integrated value of the environmental stress value by operating the personal digital assistant 150.

In the present embodiment, the example has been described in which the wearable computer 100 performs processing up to the calculation of the feature quantity of the audio data, and the personal digital assistant 150 identifies the type of the surrounding environment. The processing is, however, not limited to being shared in such a manner. For example, the personal digital assistant 150 may calculate the feature quantity of the audio data, or the wearable computer 100 may perform processing up to the identification of the type of the surrounding environment.

In the first embodiment, the example has been described in which the environment around the user is identified based on the audio data detected from the environment around the user, and the stress level of the user is estimated from the surrounding environment. The first embodiment, however, does not limit the stress level of the user to being estimated from the surrounding environment. Hence, in a second embodiment, an example will be described in which the stress level of the user is estimated by combining the biological information of the user with the surrounding environment.

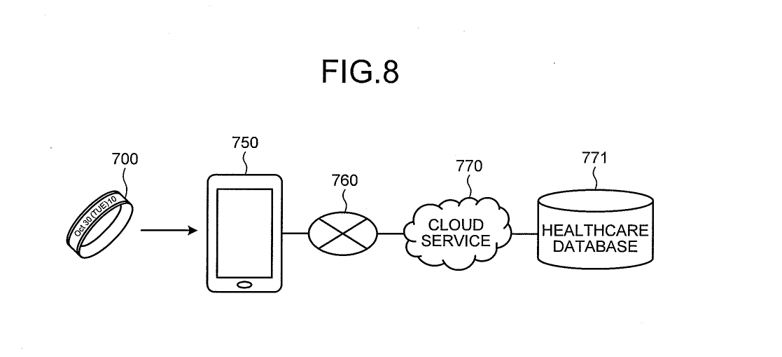

FIG. 8 is a diagram illustrating a configuration example of an information system according to the second embodiment. As illustrated in FIG. 8, the information system comprises a wearable computer 700, a personal digital assistant 750, a public network 760, a cloud service 770, and a healthcare database 771.

In the present embodiment, when the cloud service 770 has received information (such as the biological information and information on the stress value) stored in the personal digital assistant 750, the cloud service 770 sends, for example, advice to the personal digital assistant 750 with reference to the healthcare database 771. The wearable computer 700 detects the biological information for this purpose.

In the present embodiment, if the wearable computer 700 is worn on a part of the body of the user, the wearable computer 700 detects the biological information (such as a pulse wave) of the user, and sends it to the personal digital assistant 750. The personal digital assistant 750 performs a pulse rate calculation and an autonomic nerve analysis based on the received biological information, and calculates the activity level of the sympathetic nerves LF/HF. Based on the activity level LF/HF and the type of the surrounding environment, the personal digital assistant 750 calculates the stress level of the user, and sends the stress level to the cloud service 770, whereby the personal digital assistant 750 can receive various kinds of advice. The hardware configurations of the wearable computer 700 and the personal digital assistant 750 are the same as those of the first embodiment, so that description thereof will be omitted.

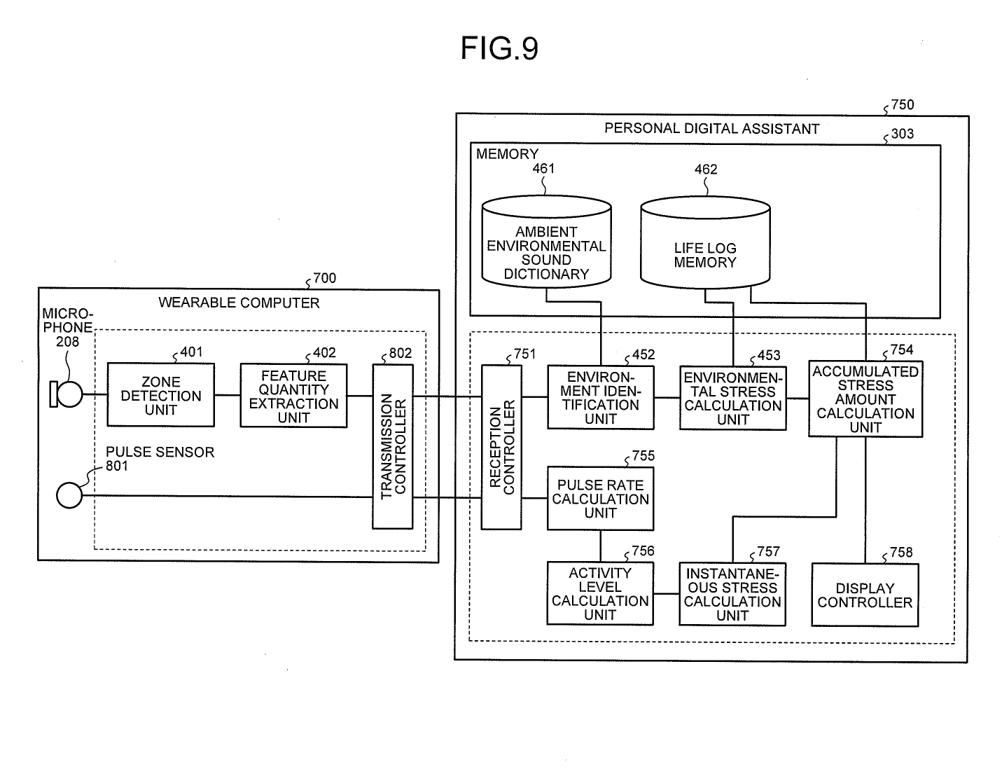

A description will be given of configurations implemented in the wearable computer 700 and the personal digital assistant 750 by executing the programs. FIG. 9 is a block diagram illustrating the configurations in the wearable computer 700 and the personal digital assistant 750 of the present embodiment. In the present embodiment, the same reference numerals are given to the configurations that perform the same processes as those of the first embodiment, and description thereof will be omitted.

As illustrated in FIG. 9, in the wearable computer 700, the processor 202 implements at least the zone detection unit 401, the feature quantity extraction unit 402, and a transmission controller 802 by executing the programs stored in the memory 203.

The transmission controller 802 controls transmission of data to another electronic device (such as the personal digital assistant 750) via the wireless communication module 201. In the present embodiment, the transmission controller 802 controls transmission of the feature quantity of the audio data extracted by the feature quantity extraction unit 402 and pulse wave data obtained from a pulse wave sensor 801 included in the biological information sensor group 205, to the personal digital assistant 750.

As illustrated in FIG. 9, in the personal digital assistant 750, the processor 302 implements at least a reception controller 751, the environment identification unit 452, the environmental stress calculation unit 453, an accumulated stress amount calculation unit 754, a pulse rate calculation unit 755, an activity level calculation unit 756, an instantaneous stress calculation unit 757, and a display controller 758 by executing the programs stored in the memory 303.

The reception controller 751 controls reception of data from another electronic device (such as the wearable computer 700) via the wireless communication module 301. In the present embodiment, the reception controller 751 controls reception of the feature quantity of the audio data and the pulse wave data from the wearable computer 700.

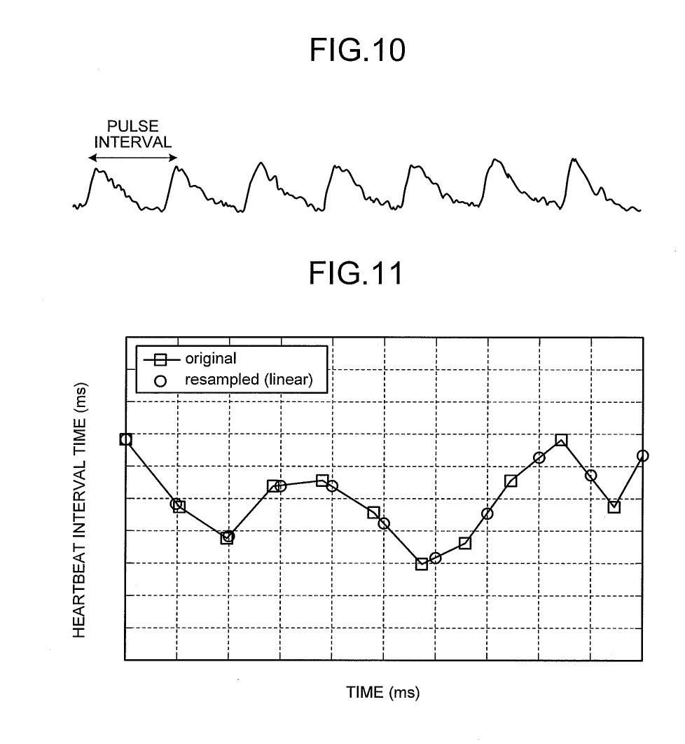

The pulse rate calculation unit 755 calculates information on the pulse beats based on the received pulse wave data. FIG. 10 is a diagram illustrating the pulse wave data of the present embodiment. The pulse rate calculation unit 755 of the present embodiment calculates the peak-to-peak distance of the pulse wave data illustrated in FIG. 10 as a pulse interval.

In addition, the pulse rate calculation unit 755 interpolates the pulse intervals, and then converts the results into isochronous data. FIG. 11 is a diagram illustrating an example in which the pulse intervals are changed to convert the data into the isochronous data. FIG. 11 illustrates the example of calculating the isochronous data based on the points “original” detected from the pulse wave data and the interpolated points “resampled”. While the present embodiment uses a linear interpolation, a spline interpolation may be used. The pulse rate calculation unit 755 outputs the calculated isochronous data to the activity level calculation unit 756.

The activity level calculation unit 756 calculates a power spectral density from the isochronous data. To calculate the power spectral density, any method may be used, including known methods using, for example, discrete Fourier transformation.

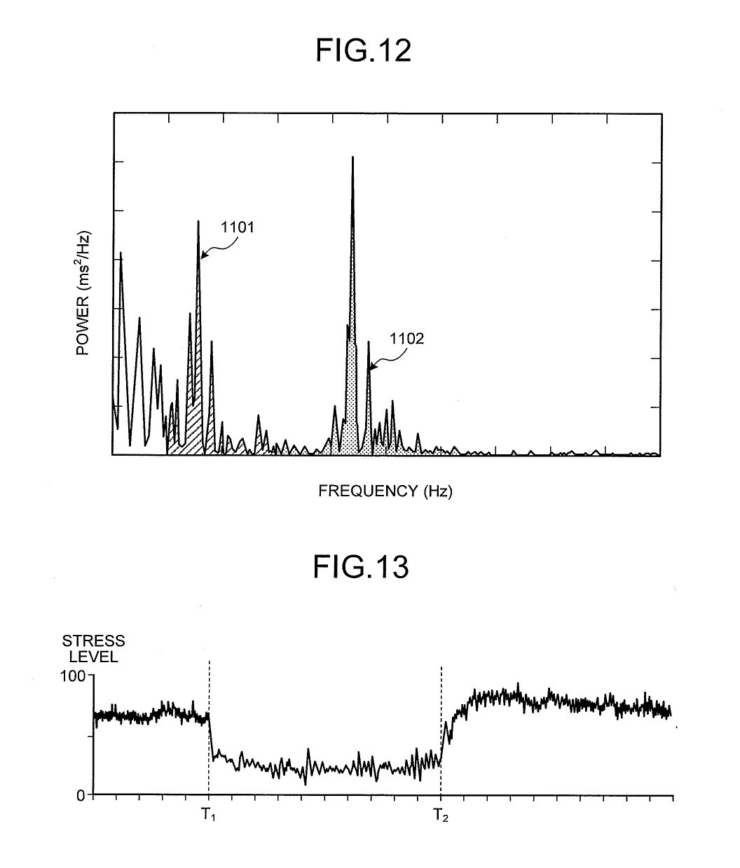

FIG. 12 is a diagram illustrating the power spectral density calculated from the pulse wave data. As illustrated in FIG. 12, a region 1101 represents the intensity of low-frequency (LF) components, and a region 1102 represents the intensity of high-frequency (HF) components 1102. The activity level calculation unit 756 of the present embodiment outputs the activity level of the sympathetic nerves LF/HF to the instantaneous stress calculation unit 757.

Based on the activity level of the sympathetic nerves LF/HF, the instantaneous stress calculation unit 757 calculates the instantaneous stress value. The instantaneous stress calculation unit 757 of the present embodiment calculates the instantaneous stress value represented in the range of 0 to 100, from the activity level LF/HF. A smaller instantaneous stress value indicates that the user is more relaxed. FIG. 13 is a diagram illustrating a transition of the instantaneous stress value. The example illustrated in FIG. 13 indicates that the state is a relaxed state between times T₁ and T₂, and is a stressed state during the other period.

The accumulated stress amount calculation unit 754 adjusts the instantaneous stress value using the environmental stress value, and then calculates an accumulated stress amount by smoothing or integrating the result.

Thus, by providing the configuration described above, the processor 302 of the present embodiment can calculate the instantaneous stress value of the user based on the biological data detected by the biological information sensor group 205 included in the wearable computer 700, and can adjust the calculated instantaneous stress value based on the type of the surrounding environment (environmental stress value).

The display controller 758 controls display, on the display unit 151, of, for example, the accumulated stress amount calculated by the accumulated stress amount calculation unit 754 and the advice sent from the cloud service 770.

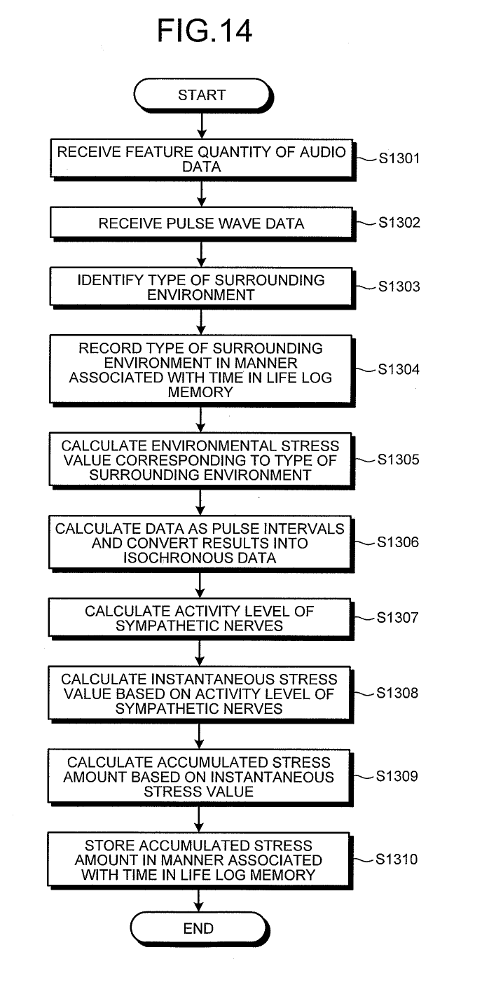

A description will be given of a processing procedure until the accumulated stress amount is recorded in the personal digital assistant 750. FIG. 14 is a flowchart illustrating the above-described processing procedure in the personal digital assistant 750 of the present embodiment.

First, the reception controller 751 receives the feature quantity of the audio data from the wearable computer 700 (S1301). The reception controller 751 receives the pulse wave data from the wearable computer 700 (S1302).

Then, the environment identification unit 452 identifies the type of the surrounding environment based on the ambient environmental sound dictionary 461 and the feature quantity of the audio data (S1303).

The environment identification unit 452 then records the type of the surrounding environment, in a manner associated with time, in the life log memory 462 (S1304).

Thereafter, with reference to the ambient environmental sound dictionary 461, the environmental stress calculation unit 453 calculates the environmental stress value corresponding to the type of the surrounding environment (S1305).

Then, the pulse rate calculation unit 755 calculates the peak-to-peak distance of the received pulse wave data as the pulse interval, and, after interpolating the pulse intervals, converts the results into the isochronous data (S1306).

The activity level calculation unit 756 calculates the activity level of the sympathetic nerves LF/HF from the isochronous data (S1307).

Based on the activity level of the sympathetic nerves LF/HF, the instantaneous stress calculation unit 757 calculates the instantaneous stress value (S1308).

The accumulated stress amount calculation unit 754 then adjusts the instantaneous stress value using the environmental stress value, and then calculates the accumulated stress amount (S1309).

The accumulated stress amount calculation unit 754 then stores the accumulated stress amount, in a manner associated with time, in the life log memory 462 (S1310).

In the present embodiment, the above-described processing procedure records the stress level adjusted according to the type of the surrounding environment in the life log memory 462. Thus, the accumulated stress amount is calculated taking into account the information on where the user resides in addition to the information detected by the pulse wave sensor 801, so that the stress level of the user can be expressed in higher accuracy.

By identifying the type of the environment around the user based on the audio data, the present embodiment eliminates the need for using the Global Positioning System (GPS), and can thereby reduce energy consumption.

Moreover, while it is difficult to determine from position information on the map whether the user resides at a place giving the user stress, the present embodiment enables the determination as to whether the place gives the user stress by identifying the type of the surrounding environment.

Sensors other than the microphone 208 may be used to calculate the environmental stress value. Hence, an example of using various sensors will be described as a modification of the present invention.

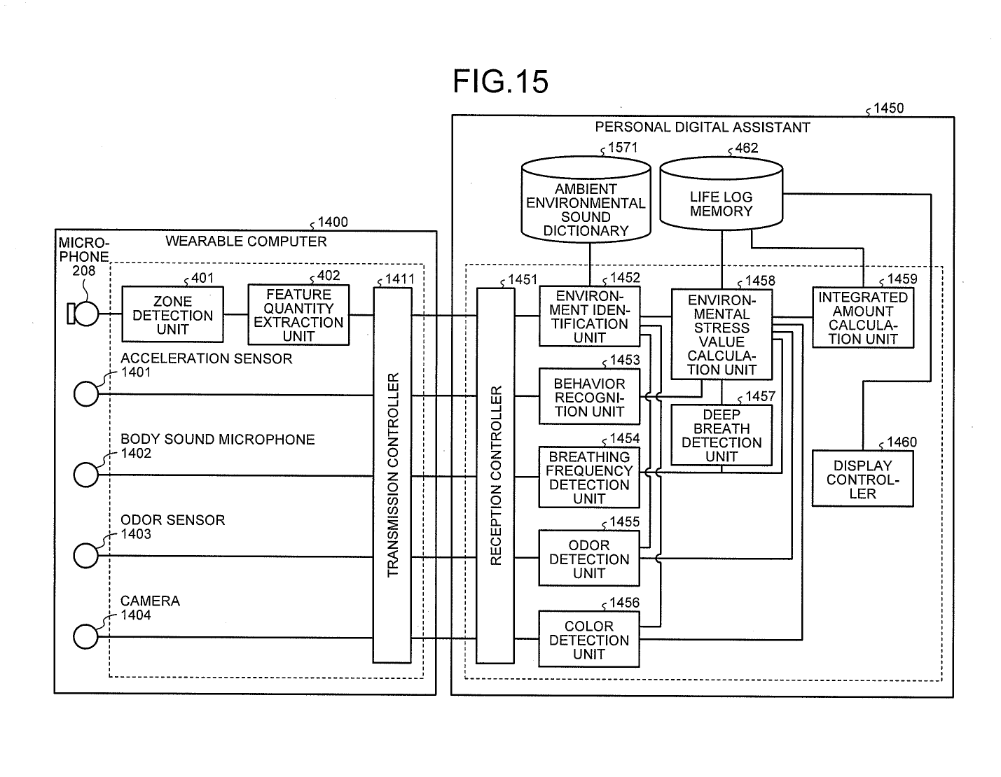

A description will be given of configurations implemented in a wearable computer 1400 and a personal digital assistant 1450 of the present modification by executing the programs. FIG. 15 is a block diagram illustrating the configurations in the wearable computer 1400 and the personal digital assistant 1450 of the modification. In the present embodiment, the same reference numerals are given to the configurations that perform the same processes as those of the first and the second embodiments, and description thereof will be omitted.

As illustrated in FIG. 15, in the wearable computer 1400, the processor 202 implements at least the zone detection unit 401, the feature quantity extraction unit 402, and a transmission controller 1411 by executing the programs stored in the memory 203.

The transmission controller 1411 controls transmission of data to another electronic device (such as the personal digital assistant 1450) via the wireless communication module 201. In the present embodiment, the transmission controller 1411 controls transmission of the feature quantity of the audio data extracted by the feature quantity extraction unit 402, an acceleration detected by an acceleration sensor 1401, body sound data detected by a body sound microphone 1402, odor data detected by an odor sensor 1403, and image data obtained by imaging the surrounding environment with a camera 1404, to the personal digital assistant 1450.

As illustrated in FIG. 15, in the personal digital assistant 1450, by executing the programs stored in the memory 303, the processor 302 implements at least the following units: a reception controller 1451; an environment identification unit 1452; a behavior recognition unit 1453; a breathing frequency detection unit 1454; an odor detection unit 1455; a color detection unit 1456; a deep breath detection unit 1457; an environmental stress value calculation unit 1458; an integrated amount calculation unit 1459; and a display controller 1460.

The reception controller 1451 controls reception of data from another electronic device (such as the wearable computer 1400) via the wireless communication module 301. In the present embodiment, the reception controller 1451 controls reception of the feature quantity of the audio data, the acceleration, the body sound data, the odor data, and the image data obtained by imaging the surrounding environment, from the wearable computer 1400.

Based on the received acceleration data, the behavior recognition unit 1453 determines whether the traveling speed of the user is a first speed or lower, and outputs the determination result to the environmental stress value calculation unit 1458. In the present embodiment, the first speed is set as a reference speed at which the user is presumed to be walking, but another speed may be set as the reference. The behavior recognition unit 1453 may further determine whether a hand of the user is moving.

The breathing frequency detection unit 1454 detects the breathing frequency of the user based on the body sound data.

Based on the breathing frequency detected by the breathing frequency detection unit 1454, the deep breath detection unit 1457 determines whether the user is taking a deep breath, and outputs the determination result to the environmental stress value calculation unit 1458.

The odor detection unit 1455 detects the type of an odor based on the odor data. In the present embodiment, the odor detection unit 1455 detects, for example, whether the type of the odor is that of a scent of a flower or a forest, a pungent odor, or a bad odor.

The color detection unit 1456 detects a green color representing a forest or a blue color representing a sea or a sky, based on the image data obtained by imaging the surrounding environment.

Based on the feature quantity of the audio data, the type of the odor detected by the odor detection unit 1455, and the color (such as the green color representing a forest and the blue color representing a sea or a sky) detected by the color detection unit 1456, the environment identification unit 1452 identifies the type of the surrounding environment in which the user resides. In the present embodiment, the types of odors, the colors, and others may additionally be associated with, for example, the environment IDs in an ambient environmental sound dictionary 1571. Then, the environment identification unit 1452 outputs the environment ID representing the type of the environment around the user.

The environment identification unit 1452 also continues to register the environment ID indicating the identified type of the environment and time, in a manner associated with each other, in the life log memory 462.

With reference to the ambient environmental sound dictionary 1571, the environmental stress value calculation unit 1458 calculates, as the environmental stress value, the stress value associated with the environment ID identified by the environment identification unit 1452. In addition, the environmental stress value calculation unit 1458 adjusts the calculated environmental stress value based on, for example, whether the deep breath is being taken, the breathing frequency, fluctuations in the breathing frequency, the type of the odor, and the color.

For example, the environmental stress value calculation unit 1458 estimates, from the breathing frequency and the fluctuations in the breathing frequency, whether the stress of the user has increased or decreased, and adjusts the environmental stress value based on the estimation. Moreover, depending on the detected type of the odor, the environmental stress value calculation unit 1458 adjusts to reduce the environmental stress value if the type is that of a scent of a flower or a forest, or adjusts to increase the environmental stress value if the type is that of an unpleasant odor, such as a pungent odor or a bad odor.

As another example, the environmental stress value calculation unit 1458 adjusts to increase the environmental stress value if a large volume of exciting colors, such as red, surrounds the place where the user resides, or adjusts to reduce the environmental stress value if a large volume of green colors or the like suggesting, for example, a forest surrounds the place.

In addition, taking the detection result by the behavior recognition unit 1453 into account, if the user is determined to be at rest in a place of nature, the environmental stress value calculation unit 1458 adjusts to reduce the stress value.

If the behavior recognition unit 1453 has determined the traveling speed of the user to be the first speed or lower, the environmental stress value calculation unit 1458 calculates the environmental stress value. As a result, the environmental stress value can be accurately calculated.

The integrated amount calculation unit 1459 calculates the integrated amount based on the environmental stress value calculated by the environmental stress calculation unit 1458. The method for calculating the integrated amount is the same as that of the first embodiment, and description thereof is omitted.

The integrated amount calculation unit 1459 continues to register the calculated integrated value and time, in a manner associated with each other, in the life log memory 462. Thus, the change in the environmental stress value of the user is stored.

The display controller 1460 displays the information stored in the life log.

The present embodiment derives the stress level of the user by combining the results of a plurality of sensors, and can thereby accurately express the stress level.

While the present embodiment calculates the stress level of the user with the above-described configurations, the configurations may be combined with other configurations. For example, the configurations may be combined with the configuration group illustrated in the second embodiment that calculates the instantaneous stress value from the activity level calculated based on the pulse wave data.

According to the embodiments described above, a history about the life of the user can be stored. In addition, based on the history, it can be understood whether the environment in which the user has resided has been a stressful environment. Moreover, the state of the user can be understood. As a result, advice or the like can be more easily given based on the state of the user thus understood.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
acquire audio data obtained by collecting sounds around the electronic device; and
identify, based on the acquired audio data, a type of a surrounding environment using a density of people around the electronic device or information as to whether a surrounding natural environment is present.

2. The electronic device of claim 1, wherein
the circuitry is further configured to output a stress level of a user based on the identified type of the surrounding environment, and
the stress level of the user when people are dense around the user is higher than the stress level of the user when people are not dense around the user, or the stress level of the user when nature lies around the user is lower than the stress level of the user when nature does not lie around the user.

3. The electronic device of claim 1, wherein the circuitry is further configured to display, on a display unit, information on a time period during which the user has resided in an environment corresponding to the type of the surrounding environment.

4. The electronic device of claim 2, wherein the circuitry is further configured to:
acquire acceleration data; and
derive the stress level of the user when, based on the acquired acceleration data, a traveling speed of the user is estimated to be a first speed or lower.

5. The electronic device of claim 1, wherein the circuitry is further configured to:
acquire biological information data from a biological information detection sensor worn by the user;
calculate, based on the acquired biological information data, the stress level of the user; and
adjust the calculated stress level based on the type of the surrounding environment.

6. A method by an electronic device comprising:
acquiring audio data obtained by collecting sounds around the electronic device; and
identifying, based on the acquired audio data, a type of a surrounding environment using a density of people around the electronic device or information as to whether a surrounding natural environment is present.

7. The method of claim 6, further comprising outputting a stress level of a user based on the identified type of the surrounding environment, wherein
the stress level of the user when people are dense around the user is higher than the stress level of the user when people are not dense around the user, or the stress level of the user when nature lies around the user is lower than the stress level of the user when nature does not lie around the user.

8. The method of claim 7, further comprising displaying, on a display unit, information on a time period during which the user has resided in an environment corresponding to the type of the surrounding environment.

9. The method of claim 7, further comprising:
acquiring acceleration data; and
deriving the stress level of the user when, based on the acquired acceleration data, a traveling speed of the user is estimated to be a first speed or lower.

10. The method of claim 6, further comprising:
acquiring biological information data from a biological information detection sensor worn by the user;
calculating, based on the acquired biological information data, the stress level of the user; and
adjusting the calculated stress level based on the type of the surrounding environment.

11. A computer program product having a non-transitory computer readable medium including programmed instructions, wherein the instructions, when executed by a computer, cause the computer to perform:
acquiring audio data obtained by collecting sounds around an electronic device; and
identifying, based on the acquired audio data, a type of a surrounding environment using a density of people around the electronic device or information as to whether a surrounding natural environment is present.

12. The computer program product of claim 11, wherein the instructions, when executed by the computer, further cause the computer to perform outputting a stress level of a user based on the identified type of the surrounding environment, wherein
the stress level of the user when people are dense around the user is higher than the stress level of the user when people are not dense around the user, or the stress level of the user when nature lies around the user is lower than the stress level of the user when nature does not lie around the user.

13. The computer program product of claim 12, wherein the instructions, when executed by the computer, further cause the computer to perform displaying, on a display unit, information on a time period during which the user has resided in an environment corresponding to the type of the surrounding environment.

14. The computer program product of claim 12, wherein the instructions, when executed by the computer, further cause the computer to perform:
acquiring acceleration data; and
deriving the stress level of the user when, based on the acquired acceleration data, a traveling speed of the user is estimated to be a first speed or lower.

15. The computer program product of claim 11, wherein the instructions, when executed by the computer, further cause the computer to perform:
acquiring biological information data from a biological information detection sensor worn by the user;
calculating, based on the acquired biological information data, the stress level of the user; and
adjusting the calculated stress level based on the type of the surrounding environment.
